(19) United States
(12) Patent Application Publication
(10) Pub. No.: US 2011/0320910 A1
(43) Pub. Date: Dec. 29, 2011

(54) STORAGE MANAGEMENT METHOD AND STORAGE SYSTEM

(76) Inventors: Yi-Chun Liu, Hsinchu County (TW); Yun-Tai Kao Yang, Nantou County (TW)

(21) Appl. No.: 12/825,355

(22) Filed: Jun. 29, 2010

(51) Int. Cl. G06F 11/08; G06F 15/16; G06F 12/10

(52) U.S. Cl. 714/758; 711/209; 709/223; 714/E11.03; 711/E12.061

(57) ABSTRACT

A storage system is provided. The storage system comprises a storage media, a storage controller and a host. The storage controller is connected to the storage media. The host is connected to the storage controller, and performs a physical resource management algorithm for managing a physical resource of the storage media, so as to output at least a media operation command to the storage controller. The storage controller performs the media operation command to manage the storage media. A storage management method is also provided.

### BACKGROUND OF THE INVENTION

1. Field of the Invention

The invention generally relates to a storage system, in particular, to a storage management method and a storage system for managing a physical resource of a storage media by a host.

2. Description of Related Art

In recent years, with the improvement of the semiconductor process, the host, such as personal computer (PC), mobile phone, or digital camera, is becoming inexpensive and popular. The host can access a storage media, such as Flash memory. As the storage media has greater capacity, the management of the storage media becomes an important factor of the performance of the entire system.

Generally, there are two storage management architectures as follows. In one of the storage management architectures, the host directly connects to the storage media. However, when the electronic device faces different storage media, the incompatibility between the electronic device and the storage media may occur. In the other storage management architecture, the host accesses the storage media via a storage controller, wherein the physical resource management algorithm for managing a physical resource of the storage media is performed by the storage controller. The physical resource management algorithm includes such as a logical to physical address translation operation, a defect unit redirection operation, a parameter adjustment operation and a wear-leveling operation. However, the storage controller may have insufficient computing power and memory resource such that the performance and the reliability of the entire system may degenerate.

### SUMMARY OF THE INVENTION

A storage management method is provided which comprises: performing a physical resource management algorithm for managing a physical resource of a storage media by a host, so as to output at least a media operation command to a storage controller connected between the host and the storage media; and performing the media operation command by the storage controller for managing the storage media.

A storage system is provided which comprises a storage media, a storage controller, and a host. The storage controller is connected to the storage media. The host is connected to the storage controller and performs a physical resource management algorithm for managing a physical resource of the storage media, so as to output at least a media operation command to the storage controller. The storage controller performs the media operation command to manage the storage media.

As described above, the storage management method and the storage system utilize the host to perform the physical resource management algorithm for managing a physical resource of a storage media such that the features of less cost, more flexibility, better compatibility, enhanced performance and strong reliability are introduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows the block diagram of the storage system according to an embodiment of the invention.

FIG. 2 shows the flowchart of the storage management method according to an embodiment of the invention.

FIG. 3A shows the detail of the flowchart of the storage management method according to an embodiment of the invention.

FIG. 3B shows the flowchart of the storage management method according to another embodiment of the invention.

FIG. 4 shows the detail of the flowchart of the storage management method according to an embodiment of the invention.

FIG. 5 shows the flowchart of the storage management method according to an embodiment of the invention.

FIG. 6 shows the block diagram of the storage system according to an embodiment of the invention.

FIG. 7A shows the architecture of the storage media according to an embodiment of the invention.

FIG. 7B shows the address mapping table of the storage media according to an embodiment of the invention.

FIG. 8A shows the data structure of the translation table 8000 according to an embodiment of the invention.

FIG. 8B shows the flowchart of the method for the storage controller searching the translation table according to an embodiment of the invention.

FIG. 8C shows the flowchart of the method for the storage controller reading the translation table according to an embodiment of the invention.

FIG. 8D shows the flowchart of the method for the storage controller updating the translation table according to an embodiment of the invention.

FIG. 8E shows the flowchart of the method for the storage controller reconstructing the translation table according to an embodiment of the invention.

FIG. 9 shows the block diagram of the status of updating data in the NAND flash chip according to an embodiment of the invention.

FIG. 10 shows the block diagram of the command format according to an embodiment of the invention.

FIG. 11 shows the flowchart of the method for the storage controller reading the logical space.

FIG. 12 shows the flowchart of the method for the storage controller writing the logical space.

FIG. 13 shows the flowchart of the method for the host reading the logical space.

FIG. 14 shows the flowchart of the method for the host writing the logical space.

FIG. 15 shows the block diagram of the status of the storage controller reconstructing and updating the translation table in the NAND flash chips according to an embodiment of the invention.

FIG. 16 shows the block diagram of converting the logical address to the physical address according to an embodiment of the invention.

FIGS. 17A and 17B show the block diagram of the status of the media management driver writing data into the logical addresses according to an embodiment of the invention.

FIG. 18 shows the detail of the flowchart of the parameter adjustment operation according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

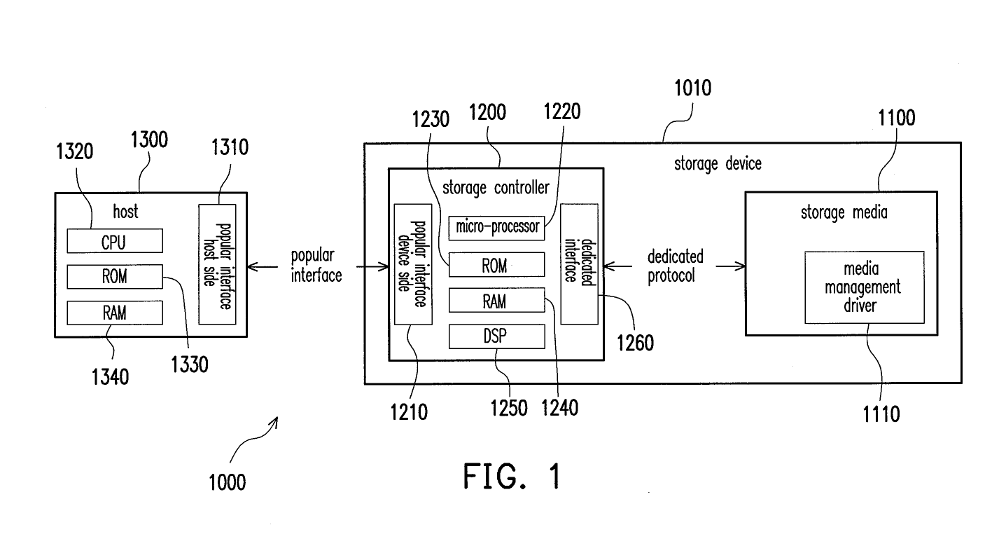

FIG. 1 shows the block diagram of the storage system according to an embodiment of the invention. Referring to FIG. 1, the storage system 1000 includes the storage device 1010 and the host 1300. The host 1300 is not limited to any specific type. Any electronic devices, such as PC, personal digital assistant (PDA), mobile phone, digital camera, multimedia recorder, multimedia player, game console, global positioning system (GPS), and so on, are all applicable to the host 1300 of the present embodiment. The storage device 1010 includes the storage media 1100 and the storage controller 1200. The storage media 1100 may be the magnetic/optical disc module or the non-volatile memory. The magnetic/optical disc module includes the discs, the heads/lens, the movement mechanism and the control circuit for accessing by the physical address, e.g. cylinder/head/sector or minute/second/block number. Examples of non-volatile memory include NAND Flash, NOR Flash, Phase Change Memory or Ferroelectric RAM. The storage controller 1200 includes the popular interface 1210, the microprocessor 1220, read-only memory (ROM) 1230, random-access memory (RAM) 1240, the digital signal processor 1250 and dedicated interface 1260. The host 1300 includes the popular interface 1310, central processing unit (CPU) 1320, ROM 1330 and RAM 1340. The media management driver 1110 is stored in the storage media 1100. In another embodiment, the media management driver 1110 may be stored in the ROM 1330, RAM 1340, other storage device, a remote device or a server. The storage controller 1200 is connected to the storage media 1100 via the dedicated interface 1260, e.g. interface of Flash memory IC. The host 1300 is connected to the storage controller 1200 via the popular interface 1210, e.g. Universal Serial Bus (USB) interface.

Regarding the data transmission between the host 1300 and the storage device 1010, the physical resource management algorithm or the storage management is performed. In the embodiment of the invention, the physical resource management algorithm includes a logical to physical address translation operation, a defect unit redirection operation, a parameter adjustment operation and/or a wear-leveling operation. If the storage media 1100 is optical disc module, the parameter adjustment operation can adjust characteristic parameter, e.g. a distance between a pickup header and an optical disc in the optical disc module. When the host 1300 is not ready to perform the physical resource management algorithm for managing the physical resource of the storage media 1100, the physical resource management algorithm is performed by the storage controller 1200. When the host 1300 performs the physical resource management algorithm, the storage controller 1200 only performs a digital data processing (DSP) operation, i.e. bridge operation, for converting the data transmitted between the host 1300 and the storage media 1100, and the physical resource management algorithm is performed by the host 1300. The bridge operation of the storage controller 1200 can help the host 1300 to control the storage media 1100 by using one or more media operation commands. The DSP operation can perform real-time data processing or convert the data transmitted between the host 1300 and the storage media 1100, e.g. Error Checking and Correction (ECC), data randomize, data compression/decompression, data encode/decode, and data encryption/decryption. The host 1300 outputs at least a media operation command to the storage controller 1200 in accordance with the result of the physical resource management algorithm, and the storage controller 1200 performs the media operation command(s) to manage the storage media 1100. In some embodiments, the media operation command may include, for example, a physical read command, a physical program command and a physical erase command shown in FIG. 10. The host 1300 outputs the media operation command(s) for writing data into the storage media 1100 or reading data from the storage media 1100.

In other embodiment, the host 1300 performs the parameter adjustment operation and outputs the media operation command with a parameter for adjusting the storage controller 1200 or the storage media 1100. The parameter may include, for example, position of pickup heads/lens of the storage media 1100, operation frequency of the storage controller 1200, or threshold voltage of read operation of the storage media 1100. The media operation command may include, for example, a read voltage adjustment command shown in FIG. 10.

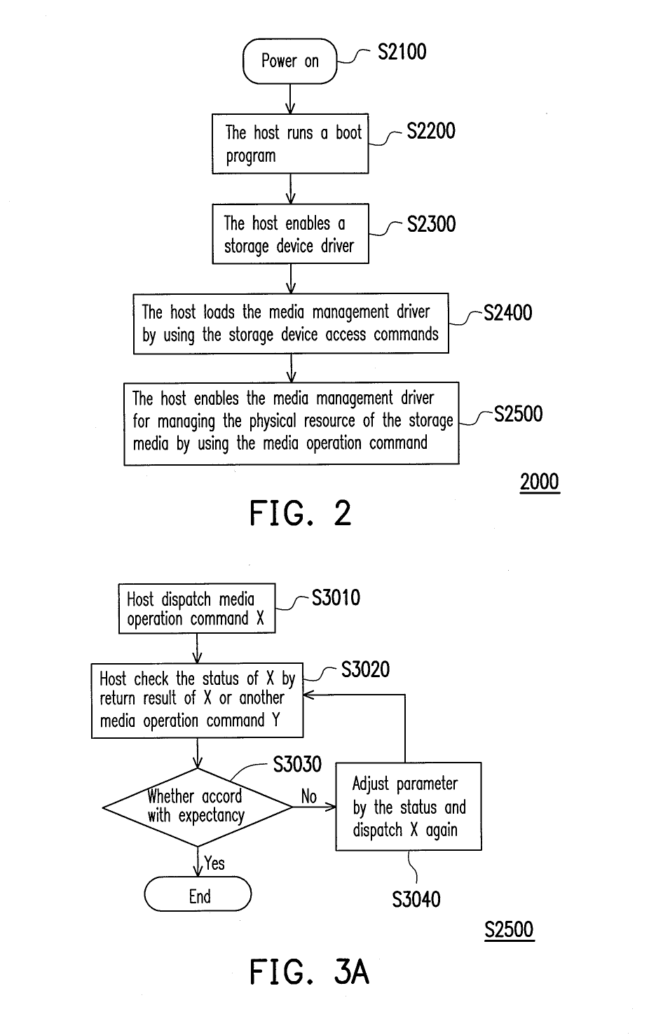

FIG. 2 shows the flowchart of the storage management method according to an embodiment of the invention. Referring to FIGS. 1 and 2, the method 2000 includes the steps S2100-S2500. In the step S2100, the host 1300 is turned on. In the step S2200, the host 1300 runs a boot program in ROM 1330 to initialize the host 1300. Then, in the step S2300, the host 1300 loads and enables a storage device driver. For example, the storage device driver is USB mass storage driver. In the step S2400, the host 1300 loads the media management driver 1110 stored in the storage media 1100 by using the storage device access commands, e.g. USB mass storage read command. In the step S2500, the host 1300 enables the media management driver 1110. The media management driver 1110 run in the host 1300 can perform the physical resource management algorithm for managing the physical resource of the storage media 1100 by using the media operation command(s). Meanwhile, the storage controller 1200 performs the DSP operation for converting the data transmitted between the host 1300 and the storage media 1100. The DSP operation may be ECC, data randomize, data compression/decompression, data encode/decode, and/or data encryption/decryption.

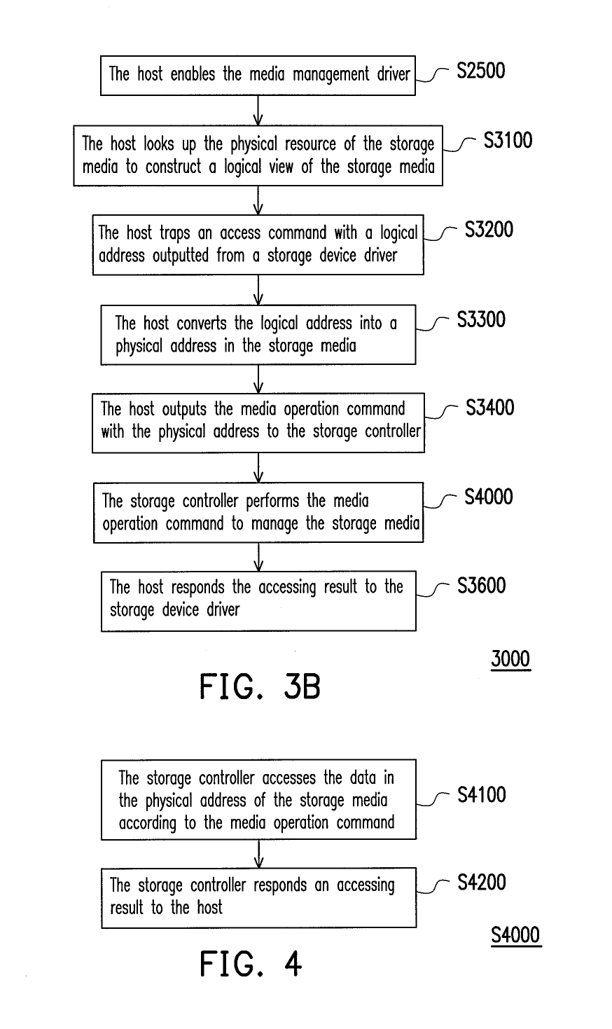

The host 1300 can perform the parameter adjustment operation and outputs the media operation command with the parameter in the step S2500 for adjusting the storage controller 1200 or the storage media 1100. FIG. 3A shows the detail of the flowchart of the storage management method according to an embodiment of the invention. Referring to FIG. 3A, the parameter adjustment operation includes the steps S3010-S3040. In the step S3010, the host 1300 dispatch the media operation command(s), e.g. media operation command X, to the storage controller 1200. For example, the host 1300 dispatch a physical read command shown in FIG. 10 to the storage controller 1200. In the step S3020, the host 1300 checks the status of the media operation command X by return result of X or another media operation command Y. The return result of X is responded from the storage controller 1200. In the step S3030, the host 1300 determines whether the status checked in the step S3020 accord with expectancy. If the status does not match the expectancy, the host 1300 performs the step S3040 for adjusting/setting at least a parameter according to the status checked in the step S3020, outputting the media operation command(s) with the parameter(s), e.g. media operation command Z, for adjusting the storage controller 1200 or the storage media 1100, and dispatching the media operation command X again. Wherein, for example, the parameter includes position of pickup heads/lens of the storage media 1100, operation frequency of the storage controller 1200, or threshold voltage of read operation of the storage media 1100. For example, the host 1300 can output a read voltage adjustment command with the threshold voltage shown in FIG. 10 to the storage controller 1200. The host 1300 performs the steps S3020 and S3030 again after the step S3040.

FIG. 3B shows the flowchart of the storage management method according to another embodiment of the invention. Referring to FIGS. 1, 2 and 3B, the method 3000 includes the steps S2500, S3100-S3400, S4000 and S3600. In the step S2500, the host 1300 enables the media management driver 1110. In the step S3100, the host 1300 looks up the physical resource of the storage media 1100 to construct a logical view of the storage media 1100 in order to manage the storage media 1100. For example, the host 1300 readouts a data structure for transferring logical address to physical address from the storage media 1100 via the storage controller 1200, and the host 1300 records the data structure in the RAM 1340 of the host 1300. If the storage media 1100 is NAND flash memory, the data structure can be a translation table of the NAND flash memory. In addition, in consideration of the consistency between the host 1300 and the storage controller 1200, the host 1300 and the storage controller 1200 utilizes the same algorithm to handle the data structure of the physical resource.

In the step S3200, the host 1300 traps an access command with a logical address outputted from a storage device driver. The access command is a request for accessing a data in the storage media 1100. In the step S3300, the host 1300 converts the logical address into a physical address in the storage media 1100. In the step S3400, the host 1300 outputs the media operation command(s) with the physical address to the storage controller 1200. The media operation command may include, for example, the physical read command, the physical program command and the physical erase command shown in FIG. 10.

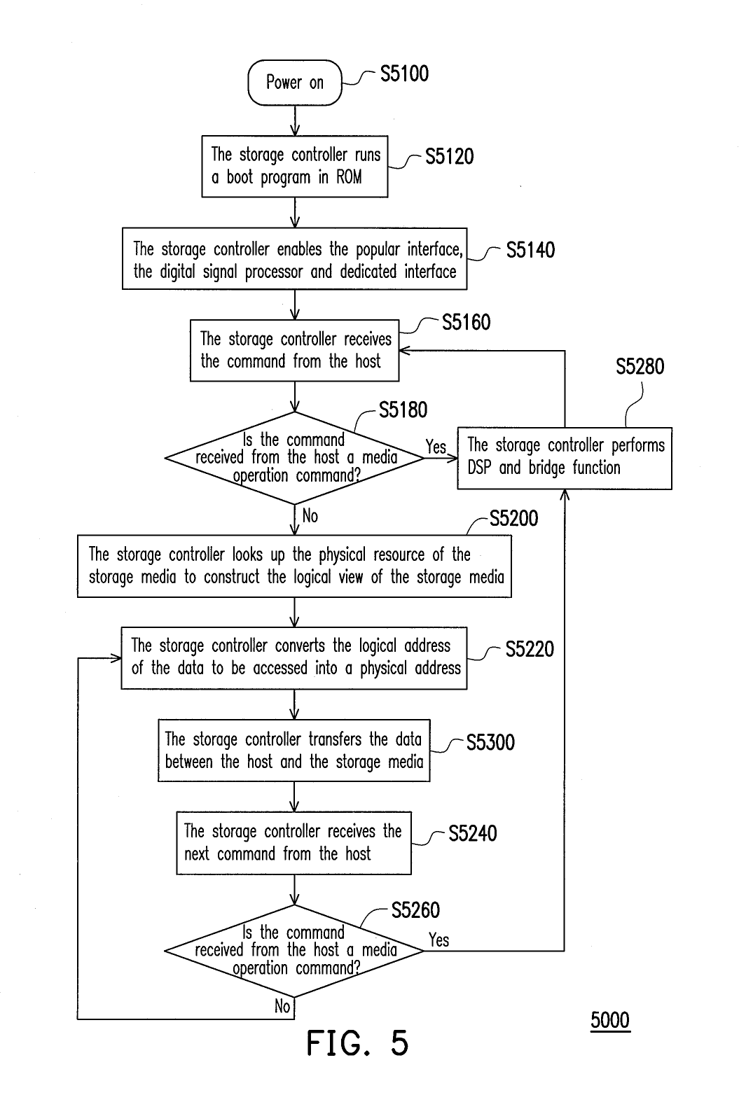

After the step S3400 of outputting the media operation command(s) with the physical address to the storage controller 1200 by the host 1300, in the step S4000, the storage controller 1200 performs the media operation command(s) to manage the storage media 1100. FIG. 4 shows the detail of the flowchart of the storage management method according to an embodiment of the invention. Referring to FIG. 4, the step S4000 includes the steps S4100-S4200. In the step S4100, the storage controller 1200 accesses the data in the physical address of the storage media 1100 according to the media operation command(s). In the step S4200, the storage controller 1200 responds an accessing result to the host 1300.

Referring to FIG. 3B again, in addition, the method 3000 may further include the step S3600. In the step S3600, the host 1300 responds the accessing result to the storage device driver. Moreover, after the step S3600, the host 1300 traps another access command with a logical address outputted from the storage device driver.

As described above, the storage management method and the storage system provides less cost, more flexibility, better compatibility, enhanced performance, strong reliability as follows:

Regarding the cost, in the storage management method and the storage system, the host utilizes existing popular interface, such as USB or SATA, such that no additional cost is required.

Regarding the flexibility, in the storage management method and the storage system, any modification of the storage media only requires the cooperation of the storage controller such that no hardware modification is made to the host. In addition, any modification of the host only requires rewriting the media management driver such that no modification is made to the storage controller.

Regarding the compatibility, the storage management method and the storage system does not suffer the incompatibility between the host and the storage device by using the popular standard interface, such as USB or SATA.

Regarding the performance, in the storage management method and the storage system, before the media management driver is loaded into the host, the storage controller having less computing power and memory resource performs the physical resource management. After the media management driver is loaded into the host, the host with significantly greater computing power and memory resource takes over the physical resource management such that the bottleneck due to performing the physical resource management by the storage controller no longer exists.

Regarding the reliability, after the media management driver is loaded into the host, the host with significantly greater computing power and memory resource performs the storage media wear-leveling operation, and monitors the storage media to prevent the system failure due to the defect of the storage media.

FIG. 5 shows a flowchart of the storage management method according to an embodiment of the invention. Referring to FIGS. 1 and 5. The method 5000 includes the steps S5100˜S5300. In the step S5100, the storage device 1010 is turned on. In the step S5120, then the storage controller 1200 runs a boot program in ROM 1230. Then, in the step S5140, the storage controller 1200 enables the popular interface 1210, the digital signal processor 1250 and dedicated interface 1260. In the step S5160, the storage controller 1200 receives the command from the host 1300. In the step S5180, the storage controller 1200 determines whether the command received from the host 1300 is the media operation command(s).

If the command received from the host 1300 is not the media operation command(s), as in the step S5200, the storage controller 1200 looks up the physical resource of the storage media 1100 to construct the logical view of the storage media 1100. The storage controller 1200 provides the logical view of the storage media 1100 to the host 1300. However, the storage controller 1200 does not provide the physical resource of the storage media 1100 to the host 1300. That is to say, the host 1300 has no information about the physical resource of the storage media 1100. In the step S5220, the storage controller 1200 converts the logical address of the data to be accessed into a physical address. In the step S5300, after the storage controller 1200 setups the storage media 1100 in accordance with the media operation command and the physical address, the digital processing processor 1250 links the popular interface 1210 and the dedicated interface 1260 such that the storage controller 1200 transfers the data between the host 1300 and the storage media 1100. In the step S5240, the storage controller 1200 receives the next command from the host 1300. Moreover, in the step S5260, the storage controller 1200 determines whether the command received in the step S5240 is the media operation command(s). Then, if the command received from the host 1300 is not the media operation command(s), the storage controller 1200 converts the logical address of the data to be accessed into a physical address without looking up the physical resource of the storage media 1100.

If the command received from the host 1300 is the media operation command(s), as in the step S5280, the storage controller 1200 performs the digital signal processing to convert the data transmitted between the host 1300 and the storage media 1100. The digital signal processing may be Error Checking and Correction (ECC), data randomize, data compression/decompression, data encode/decode, and/or data encryption/decryption. It is noted that, the operation of converting the logical address of the data to be accessed into a physical address is performed by the host 1300. In addition, the storage controller 1200 also operates as the bridge between the host 1300 and the storage media 1100.

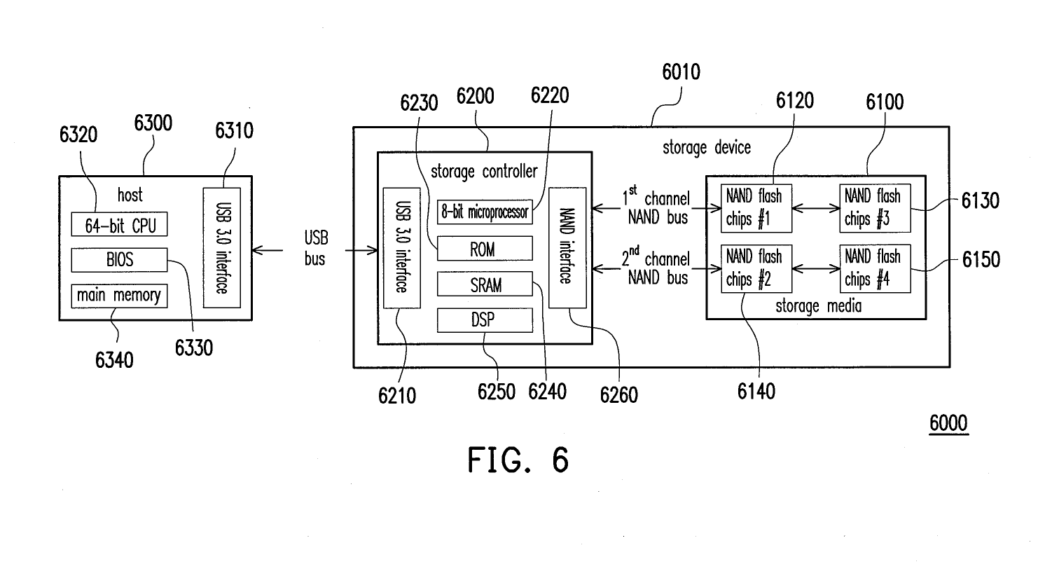

FIG. 6 shows the block diagram of the storage system according to an embodiment of the invention. Referring to FIG. 6, the storage system 6000 includes the storage device 6010 and the host 6300. The storage device 6010 includes the storage media 6100 and the storage controller 6200. The storage controller 6200 includes the USB 3.0 interface 6210, the 8-bit microprocessor 6220, ROM 6230 configured to store the firmware, SRAM 6240 configured to operate as a buffer, the NAND interface 6260, and the digital signal processor 6250 configured to provide the functions of ECC and direct memory access between the USB interface 6210 and the NAND interface 6260. The host 6300 includes the USB 3.0 interface 6310, multi-core 64-bit CPU(central processing unit) 6320, BIOS 6330 configured to boot with USB solid-state disk, and main memory 6340, such as DDR3 memory. The storage media 6100 includes four NAND flash chips 6120-6150 having the same type.

Referring to FIG. 6, the host 6300 is turned on and runs the boot program in the BIOS 6330. Then, the host 6300 enables the USB mass storage driver and loads the NAND management driver such that the host 6300 performs the physical resource management algorithm for managing the physical resource of the NAND flash chips 6120-6150. It is noted that the USB mass storage driver corresponds to the storage device driver in FIG. 3B and the NAND management driver corresponds to the media management driver in FIG. 3B.

On the other hand, the storage controller 6200 is turned on and runs the firmware in the ROM 6230. The storage controller 6200 enables the USB 3.0 interface 6210, the NAND interface 6260 and the functions of ECC and direct memory access. When the USB 3.0 interface 6210 receives an USB mass storage command, the storage controller 6200 looks up the physical resource of the storage media 6100 and converts the logical address of the data to be accessed into a physical address.

When USB 3.0 interface 6210 receives a NAND operation command instead of the USB mass storage command, the storage controller 6200 performs the digital signal processing to convert the data transmitted between the host 6300 and the storage media 6100. The storage controller 6200 converts the USB protocol into NAND bus traffic. In addition, the storage controller 1200 also operates as the bridge between the host 1300 and the storage media 1100. It is noted that, the operation of converting the logical address of the data to be accessed into a physical address is performed by the host.

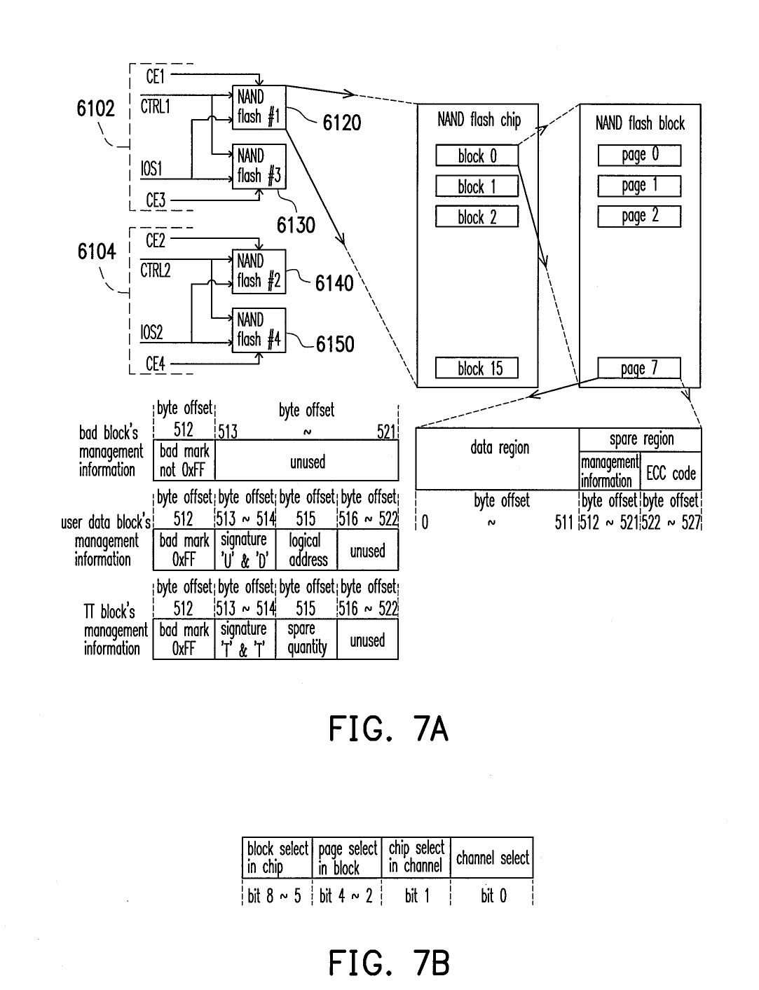

FIG. 7A shows the architecture of the storage media according to an embodiment of the invention. The NAND flash chips 6120-6150 are of the same type. Each of the NAND flash chips 6120-6130 uses the signals CTRL1 and IOS1. In addition, the NAND flash chip 6120 uses the signal CE1 and the NAND flash chip 6130 uses the signal CE3. The signals CTRL1, IOS1, CE1 and CE3 correspond to the first channel NAND bus 6102. Each of the NAND flash chips 6140-6150 uses the signals CTRL2 and IOS2. In addition, the NAND flash chip 6140 uses the signal CE2 and the NAND flash chip 6150 uses the signal CE4. The signals CTRL2, IOS2, CE2 and CE4 correspond to the second channel NAND bus 6104.

Each of the NAND flash chips 6120-6150 includes sixteen NAND flash blocks of the same structure. Each of the NAND flash blocks includes eight NAND flash pages of the same structure. Each of the NAND flash pages uses the same data structure including the data region configured to store data and the spare region configured to store additional data. The spare region includes the management information and the ECC code.

There are four different representation of the management information, such as the bad block, the user data block, the translation table block and the spare block. Regarding the bad block, the first byte of spare region is marked as a value which is not 0×FF by the flash chip manufacturer so that the first byte is for read only and is prohibited for erasing and programming. Regarding the user data block, the signature field is marked as ‘U’ and ‘D’ and the logical address of the block is attached to the signature field. Regarding the translation table block, the signature field is marked as ‘T’ and ‘T’ and the spare quantity is attached to the signature field. When the signature field is neither ‘U’ and ‘D’ nor ‘T’ and ‘T’, the block is a spare block.

FIG. 7B shows the address mapping table of the storage media according to an embodiment of the invention. When the USB mass storage driver sends the access command, the logical address may be divided into four parts. Bit 0 represents which channel the accessing target is transmitted in, wherein the value ‘0’ stored in the bit 0 corresponds to the first channel while the value ‘1’ stored in the bit 0 corresponds to the second channel. Bit 1 represents which chip in the channel the accessing target is transmitted in, wherein the value ‘0’ stored in the bit 1 corresponds to the first chip while the value ‘1’ stored in the bit 1 corresponds to the second chip. Bits 8-5 represents which block in the chip the accessing target is transmitted in, wherein the value ‘0000’ stored in the bits 8-5 corresponds to the first block while the value ‘0001’ stored in the bits 8-5 corresponds to the second block, and so on. Bits 4-2 represents which page in the block the accessing target is transmitted in, wherein the value ‘000’ stored in the bits 4-2 corresponds to the first page while the value ‘001’ stored in the bits 4-2 corresponds to the second page, and so on.

Before moving on to the details of the physical resource management algorithm, some characteristics of the NAND flash chip will be described. For example, the NAND flash chip is read in the unit of page. However, the NAND flash chip cannot be updated in the unit of page. The update of the NAND flash chip may be the combination of the erasing in the unit of block and the programming in the unit of page. Moreover, the NAND flash chip may have defect or bad block. In the embodiment, the translation table is used for dealing with the problem. The block of the translation table is always stored in the first block of each of the NAND flash chips. The first block of each of the chips is a good block approved by the manufacturer. Each of the NAND flash chips has respective translation tables such that the adjustment of the respective translation tables may be performed by each of the NAND flash chips in order to maintain different bad block conditions.

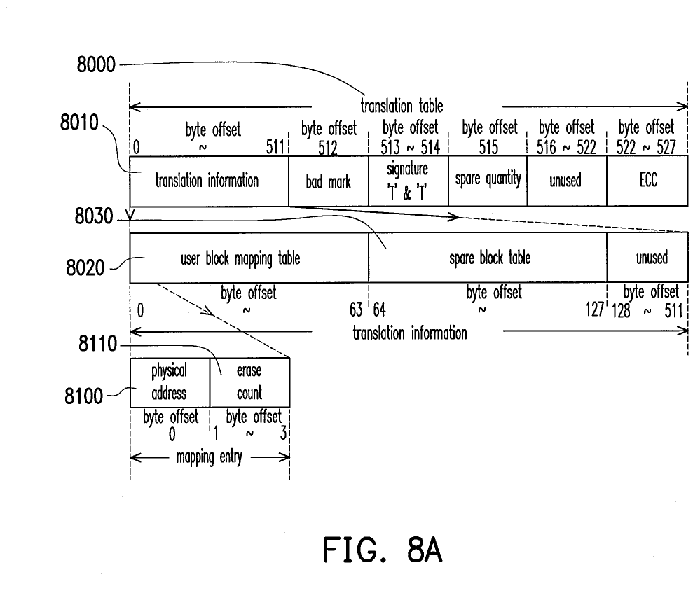

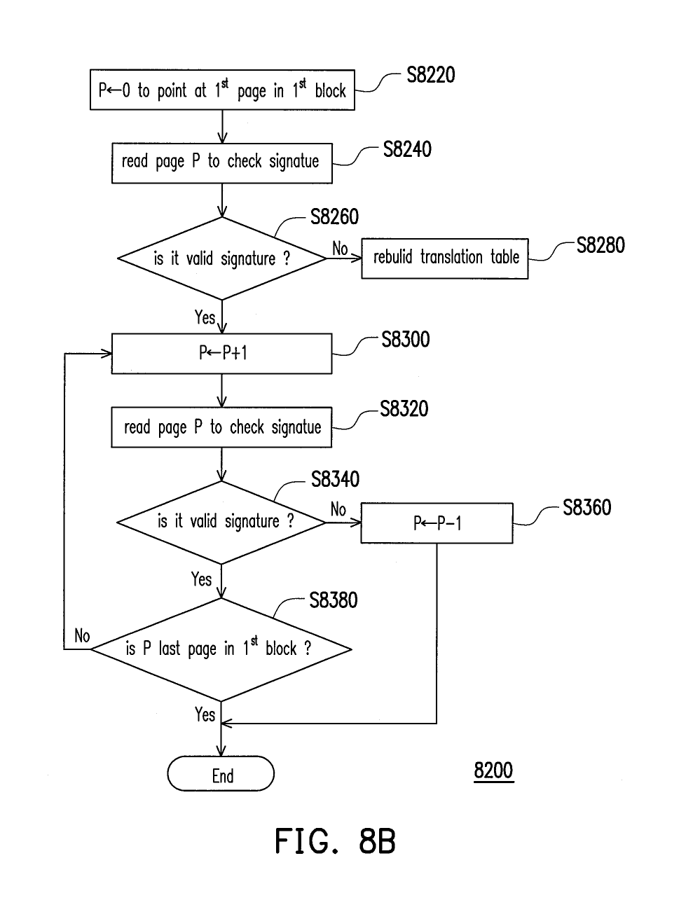

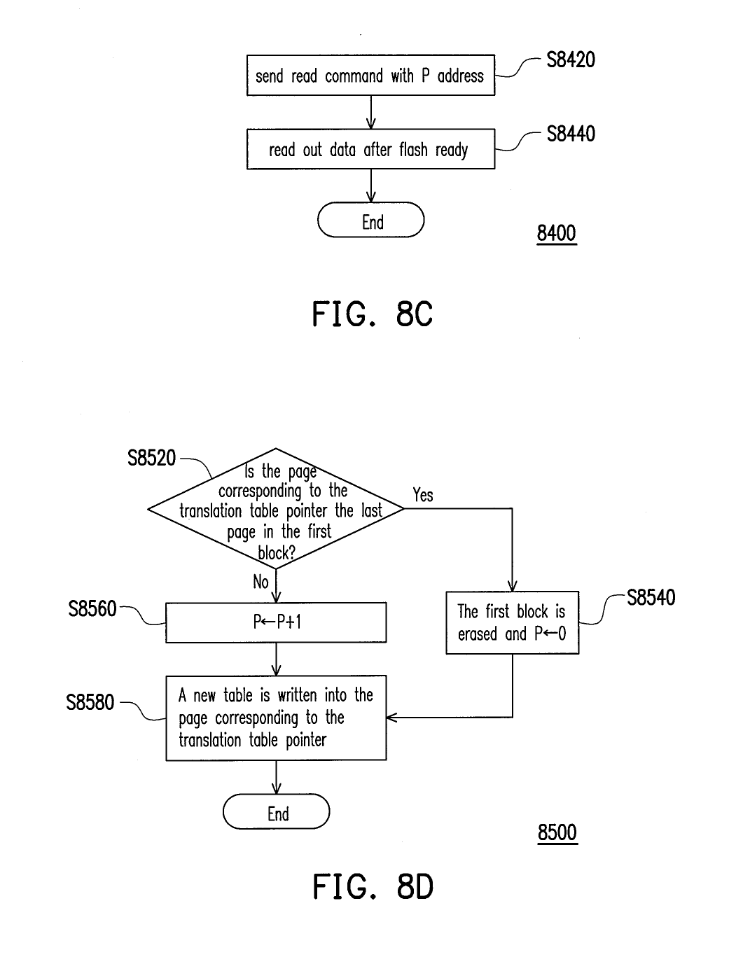

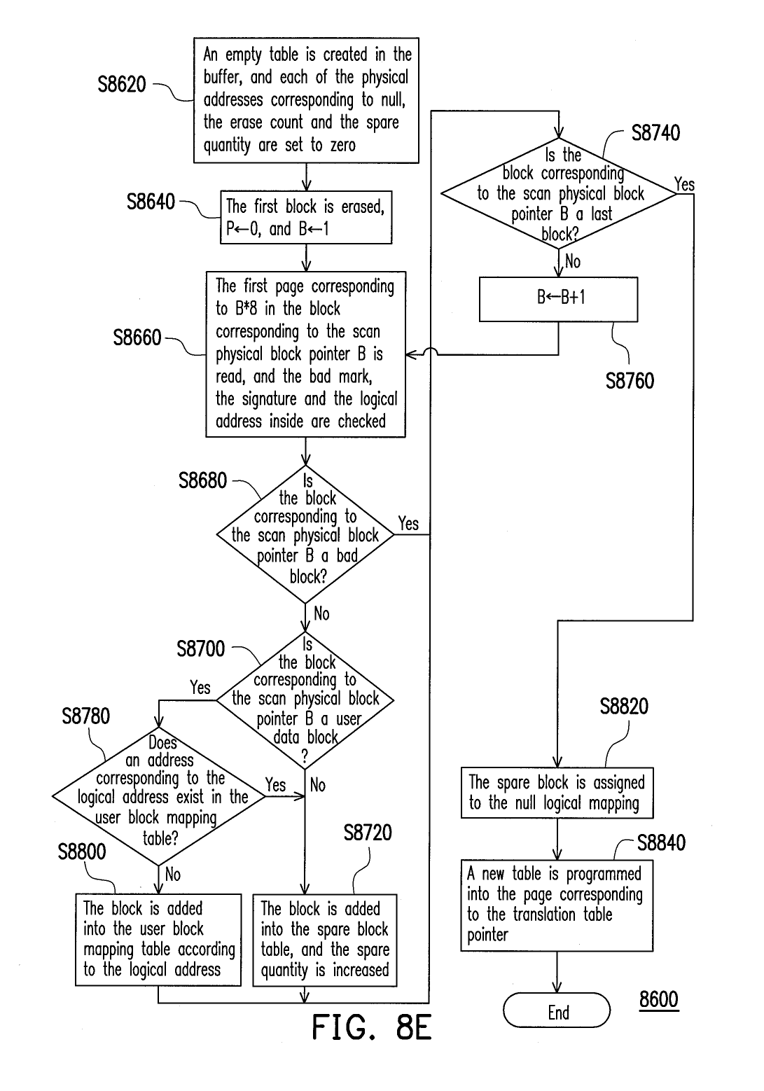

FIG. 8A shows the data structure of the translation table 8000 according to an embodiment of the invention. There is translation information 8010 in the data region. The translation information 8010 includes the user block mapping entries in the user block mapping table 8020 and the spare block mapping entries in the spare block mapping table 8030. Each of the entries has four bytes including the physical address 8100 and the erase count 8110 of the physical block. By using the translation table 8000, the logical block address may be regarded as an index to look up the corresponding physical block address. In addition, a spare block can be found by looking up the spare block table when necessary.

FIG. 8B shows the flowchart of the method for the storage controller searching the translation table according to an embodiment of the invention. The method 8200 includes the steps S8220-S8380. In the step S8220, the storage controller 6200 directs the translation table pointer P to the first page of the first block. In the step S8240, the page corresponding to the translation table pointer P is read and the signature inside is checked. In the step S8260, it is determined whether the signature is valid. In the step S8280, when the signature is invalid, the translation table is rebuilt. In the step S8300, when the signature is valid, the translation table pointer P is increased. In the step S8320, the page corresponding to the translation table pointer P is read and the signature inside is checked again. In the step S8340, it is determined whether the signature is valid. In the step S8360, when the signature is invalid, the translation table pointer P is decreased. In the step S8380, when the signature is valid, it is determined whether the page corresponding to the translation table pointer P is the last page in the first block. When the page corresponding to the translation table pointer P is the last page in the first block, the method 8200 ends. When the page corresponding to the translation table pointer P is not the last page in the first block, the translation table pointer P is increased.

FIG. 8C shows the flowchart of the method for the storage controller 6200 reading the translation table according to an embodiment of the invention. The method 8400 includes the steps S8420-S8440. In the step S8420, a read command with the translation table pointer P is sent. In the step S8440, the data in the page corresponding to the translation table pointer P is read out. After the step S8440, the method 8400 ends.

FIG. 8D shows the flowchart of the method for the storage controller 6200 updating the translation table according to an embodiment of the invention. The method 8500 includes the steps S8520-S8580. In the step S8520, it is determined whether the page corresponding to the translation table pointer P is the last page in the first block. In the step S8540, when the page corresponding to the translation table pointer P is the last page in the first block, the first block is erased and the translation table pointer P is indicated as zero. In the step S8560, when the page corresponding to the translation table pointer P is not the last page in the first block, the translation table pointer P is increased. In the step S8580, a new table is written into the page corresponding to the translation table pointer P. After the step S8580, the method 8500 ends.

FIG. 8E shows the flowchart of the method for the storage controller 6200 reconstructing the translation table according to an embodiment of the invention. The method 8600 is the details of the step S8280 in FIG. 8B and is configured to recover the damaged or faulty translation table. The method 8600 includes S8620-S8840. In the step S8620, an empty table is created in the buffer, and each of the physical addresses 8100 corresponding to null, the erase count 8110 and the spare quantity are set to zero. In the step S8640, the first block is erased, the translation table pointer P is indicated as zero, and the scan physical block pointer B is indicated as one. After the steps S8620, S8640 for initialization are finished, in the step S8660, the first page corresponding to B*8 in the block corresponding to the scan physical block pointer B is read, and the bad mark, the signature and the logical address inside are checked. In the step S8680, it is determined whether the block corresponding to the scan physical block pointer B is the bad block. In the step S8740, when the block is the bad block, it is determined whether the block corresponding to the scan physical block pointer B is the last block. In the step S8700, when the block is not the bad block, it is determined whether the block corresponding to the scan physical block pointer B is the user data block. In the step S8780, when the block is the user data block, it is determined whether an address corresponding to the logical address exists in the user block mapping table 8020. In the step S8720, when the block is not the user data block, the block is added into the spare block table 8030, and the spare quantity is increased. In the step S8800, when the address corresponding to the logical address does not exists in the user block mapping table 8020, the block is added into the user block mapping table 8020 according to the logical address. In the step S8760, when the block is not the last block, the scan physical block pointer B is increased and the step S8660 is performed. In the step S8820, when the block is the last block, the spare block is assigned to the null logical mapping. In the step S8840, a new table is programmed into the page corresponding to the translation table pointer P. After the step S8840, the method 8600 ends.

The bad block and the erasing of the operation of the translation table should be noticed. The number of the logical blocks may be less than the number of the physical blocks due to the bad block. In addition, updating the logical blocks includes erasing it such that the spare block may be used. Next, the concept of the swap block for dealing with the erasing problem will be described.

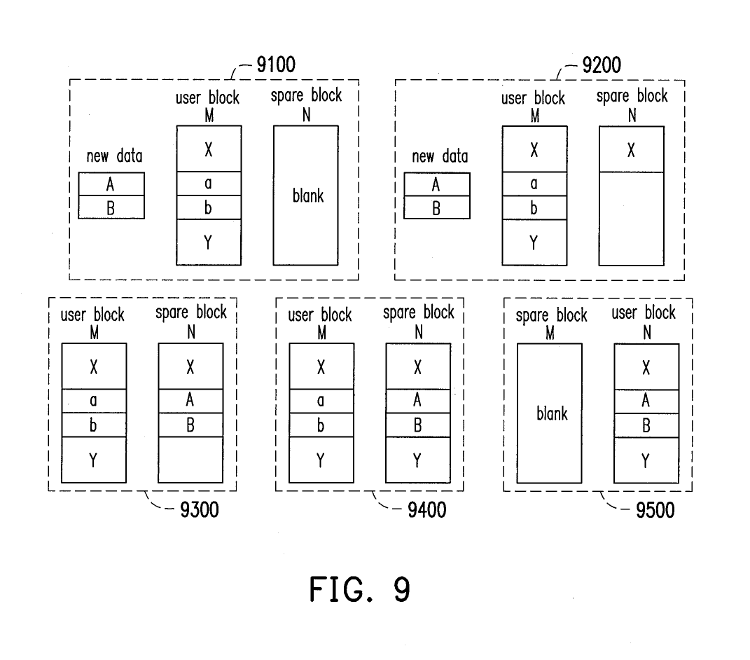

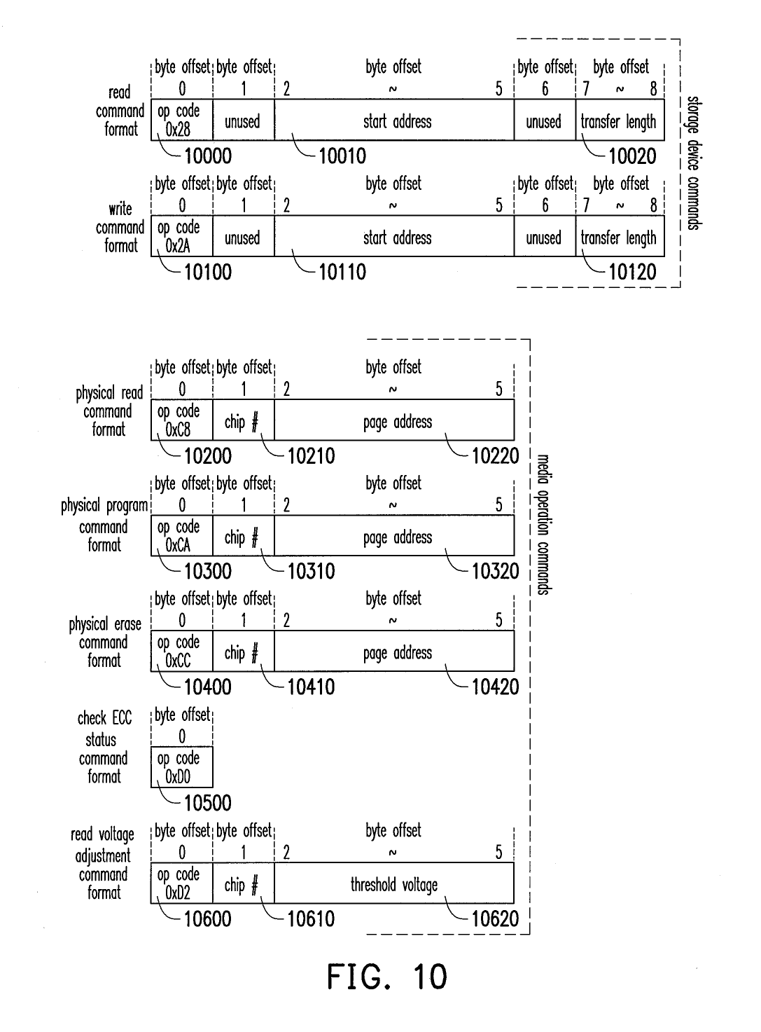

FIG. 9 shows the block diagram of the status of updating data in the NAND flash chip according to an embodiment of the invention. Each of the status 9100-9500 represents the data status during the data update. In the status 9100, new page A and B containing new data are used to replace the page a and b in the user block M. Meanwhile, there are other pages X and Y to remain the same in the user block M. In order to deal with the erasing problem, a blank spare block N is configured. In the status 9200, the pages X are read from the user block M and copied into the spare block N. In the status 9300, the pages A and B are written into the spare block N. In the status 9400, the pages Y are read from the user block M and written into the spare block N. In the status 9500, the pages in the user block M are erased to prepare for the next update. Moreover, the translation table is updated. For example, the mapping between the user block mapping table and the spare block table is swapped, and the erase count of the block M is increased. After the NAND flash chip updates data from the status 9100 to the status 9500, the updating data to the block M is found in the block N. In addition, the erasing problem does not result in losing the data that has not been updated. The technique described above is called “swap”.

FIG. 10 shows the block diagram of the command format according to an embodiment of the invention. There are seven types of command formats, such as the read command format, the write command format, the physical read command format, the physical program command format, the physical erase command format, the check ECC status command format and the read voltage adjustment command format. The first byte of the command format is the operation code representing which operation the command is used for. When the operation code (op code) is 0×00-0×BF, it means the command is a standard command. When the operation code (op code) is 0×C0-0×FF, it means the command is defined by the manufacturer. Regarding the read command format and the write command format, their operation code 10000 and 10100 are respectively 0×28 and 0×2A used for standard read/write command of the universal storage device. Regarding the physical read command format, the physical program command format, the physical erase command format, the check ECC status command format and the read voltage adjustment command format, their operation code 10200, 10300, 10400, 10500 and 10600 are respectively 0×C8, 0×CA, 0×CC, 0×D0 and 0×D2 used as the media operation command(s) described in the embodiment corresponding to FIGS. 1-5.

Moreover, regarding the read command format and the write command format, the start address 10010 and 10110 are stored in byte offset 2-5, and the transfer length 10020 and 10120 are stored in byte offset 7-8. Regarding the physical read command format, the physical program command format and the physical erase command format, the chip number 10210, 10310 and 10410 are stored in byte offset 1, and the page address 10220, 10320 and 10420 are stored in byte offset 2-5. Regarding the check ECC status command format, no information is attached to the operation code and the storage controller 6200 will return the ECC status according to the last physical read command. Regarding the read voltage adjustment command format, the chip number 10610 is stored in byte offset 1, and the threshold voltage 10620 is stored in byte offset 2-5.

Furthermore, the detail of the host 6300 loading NAND management driver via USB mass storage driver will be described as follows, wherein the storage controller 6200 provides accessing the storage media 6100 with the logical space.

As the methods disclosed in FIGS. 5 and 8A-8E, the storage controller 6200 obtains the latest translation table of each of the chips. Due to the insufficient buffer space in the storage controller 6200, the address of the translation table is recorded. Then, the translation table of the chip is loaded when the logical address is converted to the physical address.

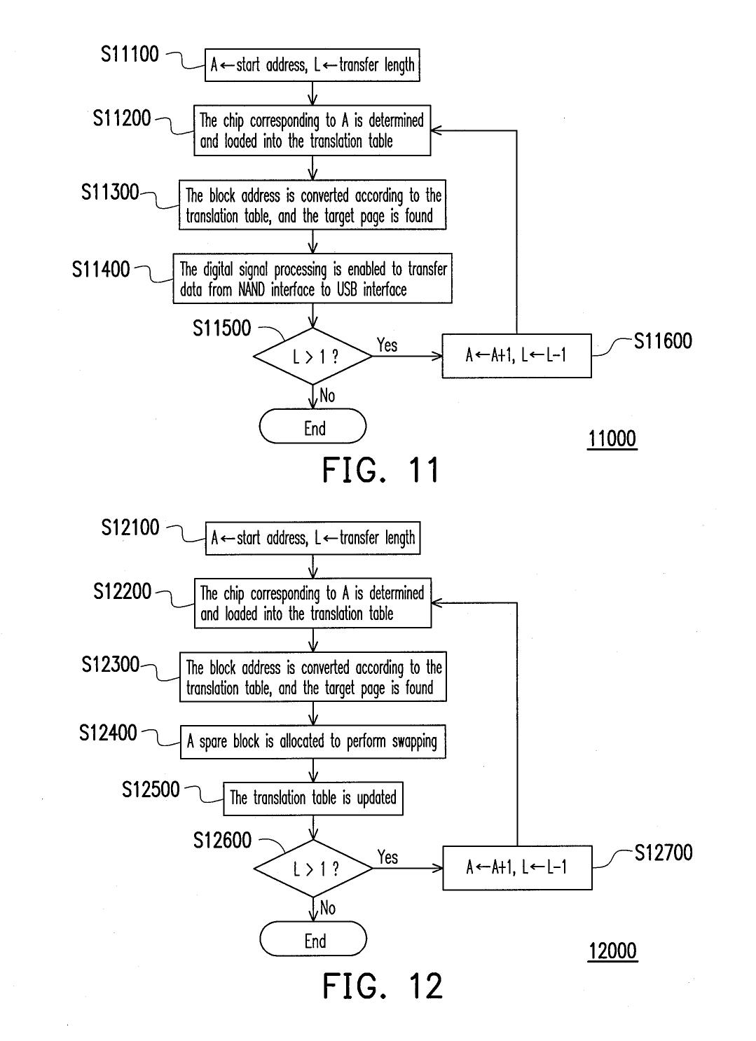

FIG. 11 shows the flowchart of the method for the storage controller 6200 reading the logical space. Referring to FIG. 11, the method 11000 includes the steps S11100-S11600. When the USB mass storage driver sends the read command, the USB SSD 6010 starts the read operation. In the step S11100, the start address is assigned to A, and the transfer length is assigned to L. In the step S11200, the chip corresponding to A is determined and loaded into the translation table according to the method in FIG. 7B. In the step S11300, the block address is converted according to the translation table, and the target page is found. In the step S11400, the digital signal processing is enabled to transfer data from NAND interface 6260 to USB interface 6210. In the step S11500, it is determined whether L is greater than one, in other words, it is determined whether there is still some data to be read. When there is still some data to be read, A is increased and L is decreased, in addition, the step S11200 is performed. When there is no data to be read, the method 11000 ends.

FIG. 12 shows the flowchart of the method for the storage controller 6200 writing the logical space. Referring to FIG. 12, the method 12000 includes the steps S12100-S12700. When the USB mass storage driver sends the write command, the USB SSD 6010 starts the write operation. In the step S12100, the start address is assigned to A, and the transfer length is assigned to L. In the step S12200, the chip corresponding to A is determined and loaded into the translation table. In the step S12300, the block address is converted according to the translation table, and the target page is found. In the step S12400, the ‘swap’ according to FIG. 9 is performed and the digital signal processing is enabled to receive the data to be written. Then, the received data is written into the address in the storage media corresponding to the logic address A. In the step S12500, the translation table is updated according to the FIG. 8D. In the step S12600, it is determined whether L is greater than one, in other words, it is determined whether there is still some data to be written. When there is still some data to be written, A is increased and L is decreased, in addition, the step S12200 is performed. When there is no data to be written, the method 12000 ends.

After the host 6300 loads NAND management driver via USB mass storage driver, as the method in FIG. 3B, the host 6300 takes over the physical resource management, i.e. NAND flash management. At this time, the storage controller 6200 has determined the translation table exist in each of the chips. The host 6300 outputs the media operation command(s) to the storage controller 6200, so as to readout a translation table from the storage media via the storage controller 6200. In addition, the translation table is recorded in the host 6300. In other embodiment, the host outputs the media operation command(s) to the storage controller, so as to readout a data structure for transferring logical address to physical address from the storage media via the storage controller, and record the data structure in the host. To be more specific, by outputting the physical read command to the storage controller 6200, the NAND management driver loaded into the host 6300 utilizes the algorithm in the FIG. 8B to readout the latest translation table such that the NAND management driver in the host 6300 obtains the logical view.

Different from the storage controller 6200, the host 6300 has much more memory. The translation tables in each of the chips may be loaded into the main memory 6340 in the host 6300. Therefore, the management is getting more efficient. On the other hand, the wear-leveling mechanism may be enabled due to the mighty computing power of the CPU 6320 inside the host 6300.

After the construction of logical view is complete, the details of the NAND management driver trapping the standard read/write commands from the USB mass storage driver similar to the step S3200 in the FIG. 3B will be described.

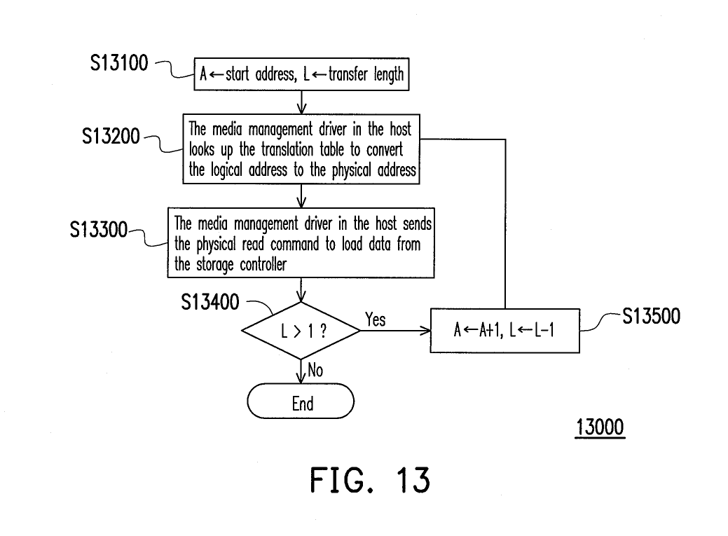

FIG. 13 shows the flowchart of the method for the host 6300 reading the logical space. Referring to FIG. 13, the method 13000 includes the steps S13100-S13500. When the media management driver in the host 6300 receives the read command from the USB mass storage driver, the method 13000 starts. In the step S13100, the start address is assigned to A, and the transfer length is assigned to L. In the step S13200, the media management driver in the host 6300 looks up the translation table stored in the main memory 6340 of the host 6300 to convert the logical address to the physical address. In the step S13300, the media management driver in the host 6300 sends the physical read command with the physical address to the storage controller 6200. Then, the storage controller 6200 retrieves the data corresponding to the physical address in the storage media 6100 and sends the data to the USB mass storage driver or to the USB mass storage driver via the media management driver in the host 6300. In the step S13400, it is determined whether L is greater than one, in other words, it is determined whether there is still some data to be read. In the step S13500, when there is still some data to be read, A is increased and L is decreased, in addition, the step S13200 is performed. When there is no data to be read, the method 13000 ends.

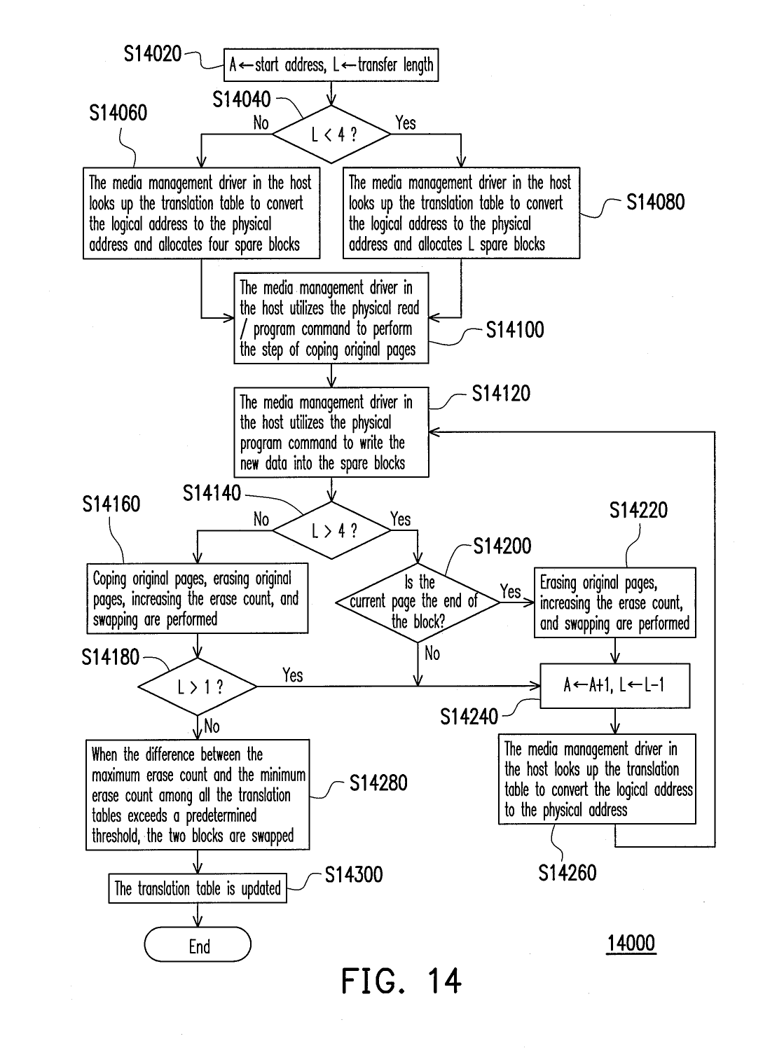

FIG. 14 shows the flowchart of the method for the host 6300 writing the logical space. There are two major differences between the method for the host 6300 writing the logical space in FIG. 14 and the method for the storage controller 6200 writing the logical space in FIG. 12. One of the differences is that the block swapping and the translation table update are executed in the unit of commands in the method in FIG. 14, while in the unit of sectors or space in the method in FIG. 12. Another difference is the utilization of the wear-leveling mechanism. Therefore, the method for the host 6300 writing the logical space has enhanced performance and strong reliability.

Referring to FIGS. 6, 7B and 14, the method 14000 includes the steps S14020-S14300. When the media management driver in the host 6300 receives the write command from the USB mass storage driver, the method 14000 starts. In the step S14020, the start address is assigned to A, and the transfer length is assigned to L. In the step S14040, it is determined whether L is less than a predetermined value. For example, the predetermined value in the embodiment is four because the storage media has four chips 6120-6150. FIG. 7B shows consecutive logical address in different chip. In the step S14080, when L is less than four, the media management driver in the host 6300 looks up the translation table to convert the logical address to the physical address and allocates L spare blocks. In the step S14060, when L is not less than four, the media management driver in the host 6300 looks up the translation table to convert the logical address to the physical address and allocates four spare blocks. In the step S14100, after allocating the spare blocks, the media management driver in the host 6300 utilizes the physical read/program command to perform the step of coping original pages as described from the status 9100 to the status 9200 in FIG. 9. Then, in the step S14120, the media management driver in the host 6300 utilizes the physical program command to write the data sent from the USB mass storage driver.

In the step S14140, after writing the data into one sector, it is determined whether L is greater than four. In the step S14200, when L is greater than four, that is, additional data will be written, it is determined whether the current page is the end of the block. In the step S14160, when L is not greater than four, that is, no additional data will be written, the steps of coping original pages, erasing original pages, increasing the erase count, and swapping as described from the status 9300 to the status 9500 in FIG. 9 is performed. In the step S14180, it is determined whether L is greater than one. In the step S14240, when L is greater than one, there is a last sector to be written into in other chips, A is increased and L is decreased. In the step S14280, when L is not greater than one, that is, all data are written, the maximum erase count and the minimum erase count among all the translation tables are determined. Then, the step of swapping the two blocks corresponding to the maximum erase count and the minimum erase count is performed when the difference between the maximum erase count and the minimum erase count exceeds a predetermined threshold. In the step S14300, the translation table is updated similar to the method in FIG. 8D. After the step S14300, the method 14000 ends.

On the other hand, in the step S14220, when the current page is the end of the block, the steps of erasing original pages, increasing the erase count, and swapping as described from the status 9400 to the status 9500 in FIG. 9 is performed. In the step S14240, A is increased and L is decreased. In the step S14260, the media management driver in the host 6300 looks up the translation table to convert the logical address to the physical address. Then, the step S14120 is performed to write the data into the next sector.

The floating gate of flash memory has issue of data retention. When the electron loss gradually from the floating gate, the host 6300 obtains more and more ECC correct error bit by the physical read command. If the error bit more than ECC ability, the correct data may be readout by adjusting the threshold voltage of read command. Therefore, the host 6300 can perform the parameter adjustment operation by using the parameter adjustment command in FIG. 10 to adjust the threshold voltage of read operation of the storage media 6100.

In other embodiment, the host 6300 can perform the parameter adjustment operation (e.g. FIG. 3A) by using the check status command and the parameter adjustment command to adjust any physical operation parameter of the storage controller 6200 and\or the storage media 6100. For example, the host 6300 can perform the parameter adjustment operation to adjust the position of pickup heads/lens in magnetic disc module or optical disc module (i.e. storage media 6100) for promoting the exactness of the readout data, or perform the parameter adjustment operation to adjust the operation frequency of the storage controller 6200 and\or the storage media 6100 for reducing the power consumption. FIG. 18 shows the detail of the flowchart of the parameter adjustment operation according to an embodiment of the invention. Referring to FIG. 18, the parameter adjustment operation includes the steps S1810-S1840. In the step S1810, the host 6300 dispatch the physical read command shown in FIG. 10 for reading a target data from the storage media 6100. In the step S1820, the host 1300 checks the ECC status of the target data by outputting a check ECC status command shown in FIG. 10 to the storage controller 6200. The storage controller 6200 receives the check ECC status command shown in FIG. 10, and then returns the ECC status according to the last physical read command. In the step S1830, the host 1300 determines whether the ECC status is correct. If the ECC status is not correct (i.e. the error bit more than ECC ability), the host 6300 performs the step S1840 for adjusting/setting a parameter (e.g. threshold voltage) according to the ECC status, outputting the read voltage adjustment command shown in FIG. 10 with the parameter to the storage controller 1200 for adjusting the threshold voltage of read operation of the storage media 1100, and dispatching the physical read command again to get correct target data.

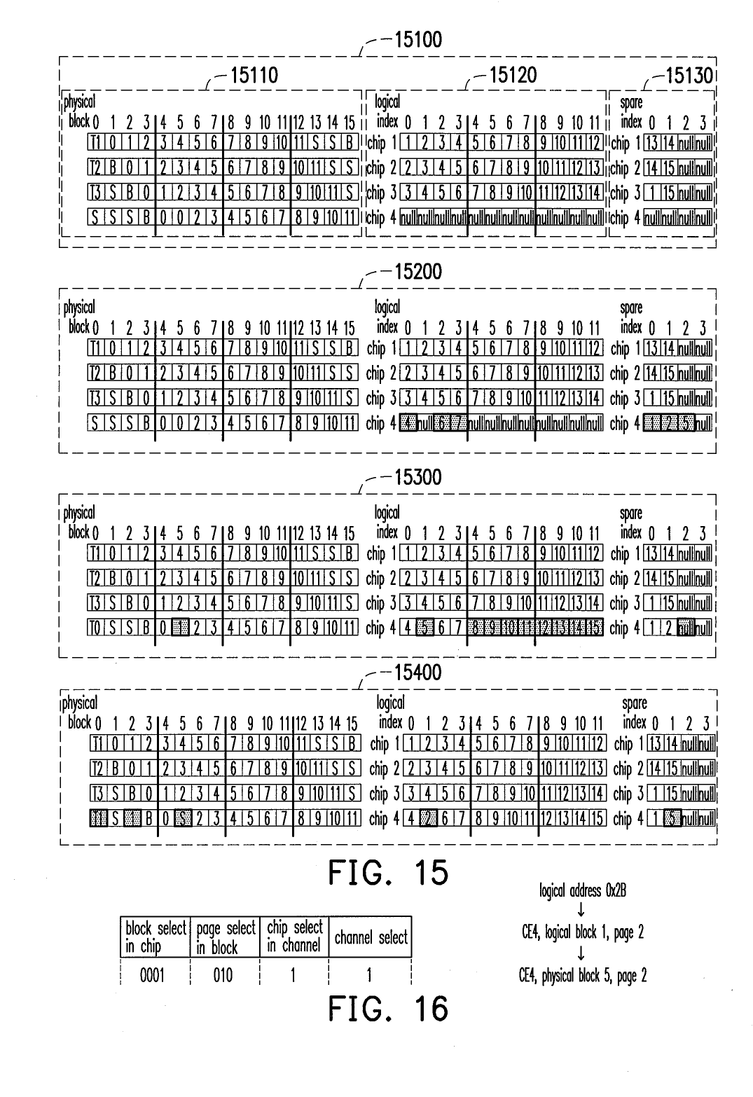

When the host 6300 is not ready to perform the physical resource management algorithm, the storage controller 6200 performs the physical resource management algorithm instead. FIG. 15 shows the block diagram of the status of the storage controller 6200 reconstructing and updating the translation table in the NAND flash chips according to an embodiment of the invention. Taking the status 15100 as an example, the left region 15100 includes the status of the sixteen blocks of the four chips, wherein Tx represents that the page x stores the latest translation table, B represents the bad block, S represents the spare block, and the other numbers represents the logical block. The middle region 15120 represents the user block mapping table 8020 in FIG. 8A. The right region 15130 represents the spare block table 8030 in FIG. 8A.

The status 15100 shows the initial state of the NAND flash chips. The chip four 6150 in the left region 15100 does not has any translation table such that the reconstruction starts according to the FIG. 8E. It is noted that, logical block 0 is found in the physical block four of the chip four 6150 and another logical block 0 is found in the physical block five of the chip four 6150. Therefore, the physical block five of the chip four 6150 is regarded as the spare block. The status 15200 shows the state of the NAND flash chips when the reconstruction is performed on the physical block one of the chip four 6150 till the physical block seven of the chip four 6150. Then, the physical blocks from one to fifteen are determined, and the spare blocks are filled correspondingly. The status 15300 shows the state of the NAND flash chips when the reconstruction is performed on the physical block one of the chip four 6150 till the physical block fifteen of the chip four 6150.

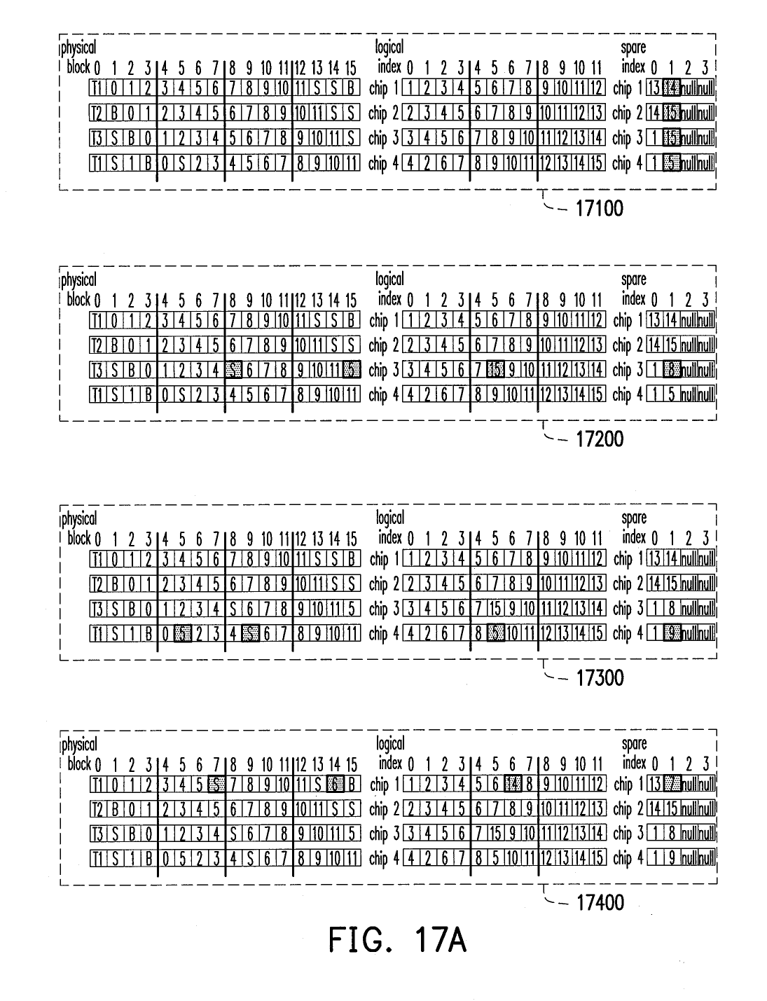

FIG. 16 shows the block diagram of converting the logical address to the physical address according to an embodiment of the invention. Referring to FIG. 16, the logical address 0×2B is divided with reference to the address mapping table FIG. 7B. Accordingly, it is determined that the logical address 0×2B corresponds to the second chip of the second channel. The storage controller loads the translation table in the chip four 6150 and looks up the translation table with the logical index one such that the storage controller obtains the physical block five. Therefore, the storage controller reads the page two in the physical block five of the chip four 6150 to obtain the data corresponding to the logical address 0×2B.

Moreover, updating the data corresponding to the logical address 0×2B requires allocating spare blocks for the swapping in FIG. 9. Referring to FIG. 15 again, the status 15400 shows the state of the NAND flash chips when the swapping completes. The physical block two stores the logical block one instead of spare block S. The physical block five stores spare block S instead of the logical block one. After the swapping, the translation table is updated into the page one to complete writing data into the logical address 0×2B.

When the host 6300 is ready to perform the physical resource management algorithm, the media management driver in the host 6300 performs the physical resource management algorithm. In other words, after the USB mass storage driver completes loading the media management driver into the host 6300 by using the standard read/write command, the media management driver in the host 6300 finds the latest translation table to construct the logical view via the physical read command. The method of the host 6300 reading the logical view is similar to the method of the storage controller 6200 reading the logical view. The major difference is that the host 6300 stores the latest translation table of all the chips in the main memory 6340. Therefore, converting the logical address to the physical address does not require the step of loading the translation table of the chip from the NAND flash chips.

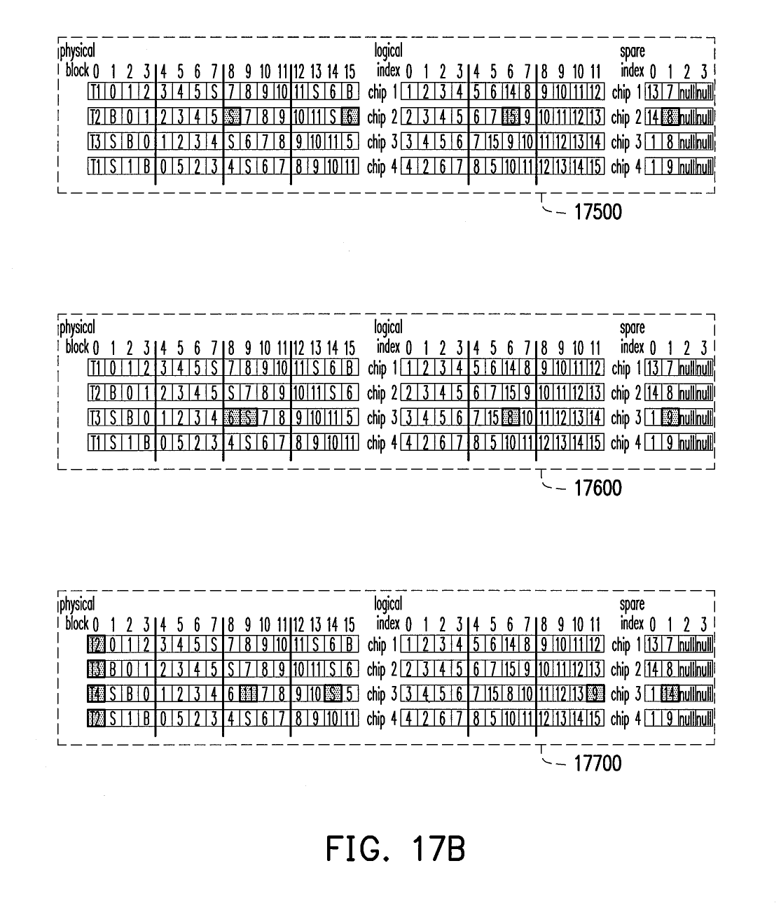

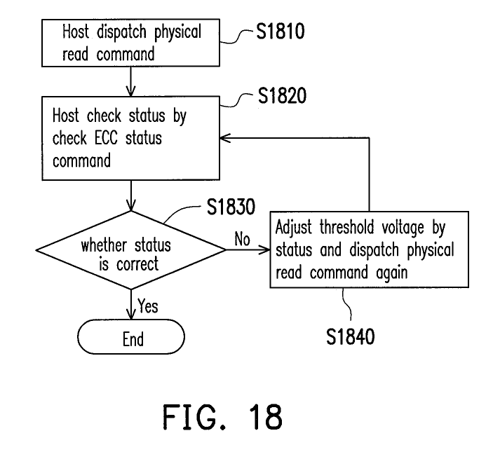

FIGS. 17A and 17B show the block diagram of the status of the media management driver writing data into the logical addresses 0×BE-0×C2 from the status of the 15400 in FIG. 15 according to an embodiment of the invention. In the beginning, the USB mass storage driver sends the standard write command with the start address being 0×BE and the transfer length being five. Then, four spare blocks are allocated according to the method in FIG. 14. The status 17100 of the FIG. 17A is provided accordingly.

In addition, the step of coping original pages as described from the status 9100 to the status 9200 in FIG. 9 is performed on the physical addresses corresponding to the logical addresses 0×BE-0×C2. Then, the data is written into the physical address corresponding to the logical address 0×BE. After that, the transfer length is greater than four, that is, other data is to be written in the same chip. However, the current page is the end of the block. Therefore, it is only required to perform the step of erasing original pages as described in the status 9500 in FIG. 9 without the step of coping original pages as described from the status 9300 the status 9400 in FIG. 9. The status 17200 of the FIG. 17A is provided accordingly.

Moreover, after writing data into the logical addresses 0×BF, it is determined the transfer length is not greater than four, that is, the data to be written is the last data in the chip. Also, the current page is the end of the block. Therefore, it is only required to perform the step of erasing original pages as described in the status 9500 in FIG. 9 without the step of coping original pages as described from the status 9300 the status 9400 in FIG. 9. The status 17300 of the FIG. 17A is provided accordingly.

The steps of writing data into the logical addresses 0×C0-0×C2 are similar to the step of writing data into the logical address 0×BF. The difference between them is that each of the step of coping original pages as described from the status 9300 the status 9400 in FIG. 9 and the step of erasing original pages as described from the status 9400 the status 9500 in FIG. 9 requires to be performed. The status 17400 of the FIG. 17A and the statuses 17500-17600 of the FIG. 17B are provided accordingly.

Furthermore, all of the erase counts are checked. Given erase counts between the physical block nine and fourteen of the chip three exceeds the predetermined threshold, the physical block nine and fourteen will be swapped. Then, the translation tables of each of the chips are updated. The status 17700 of the FIG. 17B is provided accordingly. The write command sent by the USB mass storage driver completes.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A storage management method, comprising:
performing a physical resource management algorithm for managing a physical resource of a storage media by a host, so as to output at least a media operation command to a storage controller connected between the host and the storage media; and
performing the media operation command by the storage controller for managing the storage media.

2. The storage management method as claimed in claim 1, wherein the step of performing the physical resource management algorithm by the host comprises:
looking up the physical resource of the storage media to construct a logical view of the storage media by the host;
trapping an access command with a logical address outputted from a storage device driver by the host, wherein the access command request to access a data in the storage media;
converting the logical address into a physical address in the storage media by the host; and
outputting the media operation command with the physical address to the storage controller by the host.

3. The storage management method as claimed in claim 2, wherein the step of looking up the physical resource of the storage media to construct the logical view comprises:
outputting the media operation command to the storage controller by the host, so as to readout a data structure for transferring logical address to physical address from the storage media via the storage controller; and
recording the data structure in the host.

4. The storage management method as claimed in claim 2, wherein the step of performing the media operation command by the storage controller for managing the storage media comprises:
accessing the data in the physical address of the storage media by the storage controller according to the media operation command; and
responding a accessing result to the host by the storage controller.

5. The storage management method as claimed in claim 4, wherein the step of performing the media operation command by the storage controller for managing the storage media further comprises:
performing a digital data processing (DSP) operation for converting the data transmitted between the host and the storage media, wherein the DSP operation includes Error Checking and Correction (ECC), data randomize, data compression/decompression, data encode/decode, or data encryption/decryption.

6. The storage management method as claimed in claim 4, wherein the step of performing the physical resource management algorithm by the host comprises:
responding the accessing result to the storage device driver by the host.

7. The storage management method as claimed in claim 1, wherein the media operation commands include a media operation command X, a media operation command Y and a media operation command Z, the physical resource management algorithm includes a parameter adjustment operation, and the parameter adjustment operation comprises:
dispatching the media operation command X by the host;
checking status of the media operation command X by return result of the media operation command X or by outputting the media operation command Y;
adjusting at least a parameter according to the status by the host; and
outputting the media operation command Z with the parameter for adjustment to the storage controller by the host.

8. The storage management method as claimed in claim 1, wherein the host is computer, personal digital assistant, mobile phone, digital camera, multimedia recorder, multimedia player, game console, or global positioning system.

9. The storage management method as claimed in claim 1, wherein the storage media is magnetic disc module, optical disc module or non-volatile memory.

10. The storage management method as claimed in claim 1, further comprising:
loading a media management driver into the host; and
enabling the media management driver to perform the physical resource management algorithm in the host.

11. The storage management method as claimed in claim 1, further comprising:
performing the physical resource management algorithm by the storage controller when the host is not ready to perform the physical resource management algorithm.

12. The storage management method as claimed in claim 1, wherein the physical resource management algorithm includes a logical to physical address translation operation, a defect unit redirection operation, a parameter adjustment operation or a wear-leveling operation.

13. A storage system, comprising:
a storage media;
a storage controller, connected to the storage media; and
a host, connected to the storage controller, and performing a physical resource management algorithm for managing a physical resource of the storage media, so as to output at least a media operation command to the storage controller;
wherein the storage controller performs the media operation command to manage the storage media.

14. The storage system as claimed in claim 13, wherein the host readouts a data structure for transferring logical address to physical address from the storage media via the storage controller, and records the data structure in the host.

15. The storage system as claimed in claim 13, wherein the host performs the physical resource management algorithm to look up the physical resource of the storage media to construct a logical view of the storage media, trap an access command with a logical address outputted from a storage device driver, convert the logical address into a physical address in the storage media, and output the media operation command with the physical address to the storage controller.

16. The storage system as claimed in claim 15, wherein the storage controller performs the media operation command to access data in the physical address of the storage media, and respond an accessing result to the host.

17. The storage system as claimed in claim 16, wherein the storage controller performs a DSP operation for converting the data transmitted between the host and the storage media, and the DSP operation includes ECC, data randomize, data compression/decompression, data encode/decode, or data encryption/decryption.

18. The storage system as claimed in claim 16, wherein the host responds the accessing result to the storage device driver.

19. The storage system as claimed in claim 13, wherein the media operation commands include a media operation command X, a media operation command Y and a media operation command Z, the physical resource management algorithm includes a parameter adjustment operation, and the host performs the parameter adjustment operation for dispatching the media operation command X, checking status of the media operation command X by return result of the media operation command X or by outputting the media operation command Y, adjusting at least a parameter according to the status, and outputting the media operation command Z with the parameter for adjustment to the storage controller.

20. The storage system as claimed in claim 13, wherein the host is computer, personal digital assistant, mobile phone, digital camera, multimedia recorder, multimedia player, game console, or global positioning system.

21. The storage system as claimed in claim 13, wherein the storage media is magnetic disc module, optical disc module or non-volatile memory.

22. The storage system as claimed in claim 13, wherein the host loads a media management driver, and enables the media management driver.

23. The storage system as claimed in claim 13, wherein the storage controller performs the physical resource management algorithm when the host is not ready to perform the physical resource management algorithm.

24. The storage system as claimed in claim 13, wherein the physical resource management algorithm includes a logical to physical address translation operation, a defect unit redirection operation, a parameter adjustment operation or a wear-leveling operation.
